(19) United States
(12) Patent Application Publication
(10) Pub. No.: US 2026/0319921 A1
(43) Pub. Date: Oct. 15, 2026

(54) COMPUTER-IMPLEMENTED METHOD FOR OBTAINING A CHANGE NOTIFICATION FROM SOFTWARE COVERAGE FEEDBACK DURING FUZZING OF A SOFTWARE PROGRAM; SYSTEM; COMPUTER PROGRAM; COMPUTER-READABLE DATA CARRIER

(71) Applicant: Robert Bosch GmbH, Stuttgart (DE)

(72) Inventors: Christopher Huth, Heilbronn (DE); Max Camillo Eisele, Ludwigsburg (DE)

(21) Appl. No.: 19/335,775

(22) Filed: Sep. 22, 2025

(30) Foreign Application Priority Data
Sep. 30, 2024 (DE) 10 2024 209 561.3

(51) Int. Cl. G06F 11/362

(52) U.S. Cl. CPC G06F 11/362

(57) ABSTRACT

A computer-implemented method for obtaining a change notification from software coverage feedback during the fuzzing of a software program that is executed on a hardware target. The software program is implemented with static source code instrumentation; wherein the software coverage feedback generated during execution of the software program is stored at a specified address in a memory of the hardware target. The method includes: generating input data for the software program by means of a fuzzer; transmitting the generated input data to the software program by means of the fuzzer; monitoring at least one part of the specified address of the memory by means of a debugger while the software program at least partially processes the transmitted input data; transmitting the change notification to the fuzzer when at least one change is detected in the monitored at least one part of the specified address of the memory.

### BACKGROUND INFORMATION

Fuzzing (or fuzz testing) is an automated technique for testing software. In a large number of fuzzing iterations, the software is executed with invalid, unexpected and/or random input data and monitored for exceptions such as crashes, failed built-in code assertions, potential memory leaks, etc.

For software of which the input data must be present in a predetermined data structure, fuzzers designed for this predetermined data structure can be used. The predetermined data structure is specified, for example, in a file format and/or protocol. An (efficient) fuzzer is designed to generate invalid, unexpected and/or random input data in the predetermined data structure so that an execution of a particular fuzzing iteration of the software can be started without parsing errors based on the input data. Fuzzing can be used in particular in complex software (such as software for controlling, regulating and/or monitoring a technical system) to ascertain unexpected behavior such as unexpected (program) paths and/or programming errors as well as edge cases. By gaining a better understanding of the software in this way, the software and, in particular, its security can be improved.

During the execution of the fuzzing, software coverage feedback can be generated from a software target which describes the software coverage of the software target. Such software coverage feedback (coverage-guided fuzzing) can be advantageously used in fuzzing to identify unknown program paths and/or program blocks and/or to locate programming errors in the software.

In coverage-guided fuzzing, the fuzzer can generate input data on the basis of software coverage feedback. Coverage-guided fuzzers, such as American Fuzzy Loop (AFL), typically use static source code instrumentation to obtain the software coverage feedback from the target while processing input data. The software coverage feedback can be presented as a coverage map.

Software coverage feedback can be generated by means of dynamic source code instrumentation. Typically, the execution of the tested software program is monitored during the runtime thereof in order to obtain feedback on the execution. It is usually implemented through operating system functions by using emulators or debuggers.

Alternatively, software coverage feedback can be generated by means of static source code instrumentation. To test a block coverage, source code can be added to the relevant program blocks as part of static source code instrumentation, which source code, for example, hashes the current value of the program counter and stores it as a bit index in the coverage map. An example of such a hash function is the “MurmurHash” family. Depending on the number of relevant program blocks and/or branches within the source code, the size of the software coverage feedback can range from a few bytes to several megabytes, with the software coverage feedback typically being a few kilobytes.

To test branch coverage, the address of the previous program block can also be taken into account and combined with the current value of the program counter (e.g., by means of an XOR link). This can lead to a unique identifier of a branch. This identifier can then be mapped onto the coverage map using a hash function.

Typically, the software coverage feedback generated during the fuzzing is stored. This software coverage feedback only changes when new software coverage is achieved. Coverage-guided fuzzing typically requires that software coverage feedback be provided to the fuzzer after each fuzzing iteration. This feedback can be relatively easy to obtain in a conventional software program through static code instrumentation. For an embedded system software program, using static source code instrumentation can be challenging because the software coverage feedback must be transferred from the tested system to the fuzzer after each fuzzing iteration.

To test software coverage in an embedded system, emulators can also be used to offload the execution of the actual software program to a host computer on which the fuzzer is also executed. However, setting up an emulator for a specific embedded system can be a huge effort, as the embedded software program depends on the availability of external components such as sensors and/or actuators. If these components are missing in the emulator, it can affect the execution of the software program, making it impossible to reliably test the software program.

To test the software of an embedded system by means of static source code instrumentation, a host computer is typically provided on which the fuzzer is executed. The embedded system is then monitored by means of a debugger. Static source code instrumentation can become inefficient for fuzzing because the software coverage feedback must be transferred to the host computer in each fuzzing iteration. It may therefore be necessary to transfer several kilobytes from the embedded system to the host computer after each fuzzing iteration, which can represent a huge bottleneck.

Germany Patent Application No. DE 10 2021 212 596 A1 describes a computer-implemented method for obtaining software coverage feedback during the fuzzing of software on a hardware target, wherein the hardware target has at least one breakpoint register and is configured to halt an execution of the software before executing an instruction of the software if the instruction is reached during execution of the software and a memory address of the instruction is set in the at least one breakpoint register, the method comprising setting a first breakpoint before a first instruction of the software; executing or continuing a fuzzing iteration of the software; first checking whether the first breakpoint is reached when executing or continuing the fuzzing iteration; storing first protocol information comprising the fact that the first instruction in the fuzzing iteration has been reached, and, optionally, deleting the first breakpoint if the first check is positive. The software coverage feedback during software fuzzing comprises the first protocol information.

### SUMMARY

In a first aspect of the present invention, a computer-implemented method is proposed for obtaining a change notification from software coverage feedback during the fuzzing of a software program that is executed on a hardware target. The software program is implemented with static source code instrumentation, wherein the software coverage feedback generated during the execution of the software program is stored at a specified address in a memory of the hardware target.

According to an example embodiment of the present invention, the method comprises the steps described below. The steps described can in particular be carried out in the specified order. However, a different order is also possible in principle. Furthermore, it is possible that two or more of the method steps are carried out in an overlapping manner or simultaneously. Furthermore, it is possible that one or more of the method steps are carried out once or a plurality of times. The method may comprise further method steps which are not shown. For the disclosure relating to this aspect, any further aspect, embodiment and/or definition may be referenced or referred to.

The term “fuzzing” as used herein is a broad term which should be given its ordinary and common meaning as understood by a person skilled in the art. The term is not limited to any specific or adapted meaning. The term can, without limitation, refer in particular to an automated process for testing the software program, i.e., a piece of software. The fuzzing can involve a plurality of fuzzing iterations. During a fuzzing iteration, input data is generated for the software program to be tested, i.e., the software target. The software program is executed with this input data. During a fuzzing iteration, the software program is monitored. In this monitoring, software coverage feedback can be generated from the software, which is then passed on to the fuzzer. In a subsequent fuzzing iteration, further input data can be generated on the basis of this software coverage feedback.

The term “hardware target” as used herein is a broad term which should be given its ordinary and common meaning as understood by a person skilled in the art. The term is not limited to any specific or adapted meaning. The term may, without limitation, refer in particular to hardware that acts as an embedded system and on which the software program is executed. The hardware target can in particular be designed as a microcontroller.

The term “software coverage” or code coverage as used herein is a broad term which should be given its ordinary and common meaning as understood by a person skilled in the art. The term is not limited to any specific or adapted meaning. The term can, without limitation, refer in particular to a metric that indicates how much of the source code of a software program is executed during a fuzzing iteration. The software coverage may be or comprise block coverage. The block coverage can indicate what proportion of the tested program blocks is executed. Alternatively or additionally, the block coverage can specify which program blocks are executed. Alternatively or additionally, the software coverage may be or comprise path coverage. The path coverage can indicate what proportion of the tested program paths is executed. Alternatively or additionally, the path coverage can specify which program paths are traversed. Software coverage can be generated in each fuzzing iteration. In the event that the software coverage changes, the software coverage stored in the memory of the software coverage may change. The “software coverage feedback” may comprise data about the software coverage. The software coverage feedback may indicate the program blocks and/or program paths that are executed depending on the input data, preferably in the form of a coverage map. The software coverage feedback can be provided by the fuzzer to generate further input data.

The software coverage feedback may be or comprise a bit-indexed coverage map. The term “bit-indexed coverage map” as used herein is a broad term which should be given its ordinary and common meaning as understood by a person skilled in the art. The term is not limited to any specific or adapted meaning. The term may, without limitation, refer in particular to a data structure used to track software coverage during the fuzzing. The bit-indexed coverage map can consist of a bitmap in which each bit can represent a specific program section. A set bit can indicate whether a specific program section has been executed.

The term “static source code instrumentation” as used herein is a broad term which should be given its ordinary and common meaning as understood by a person skilled in the art. The term is not limited to any specific or adapted meaning. The term may, without limitation, refer in particular to a method in which additional code is inserted into the source code files of a software program in order to be able to monitor its behavior during execution. The static source code instrumentation can be performed in such a way that the at least one program block and/or the at least one program path that is traversed during a fuzzer iteration is traceable.

The term “specified address” as used herein is a broad term which should be given its ordinary and common meaning as understood by a person skilled in the art. The term is not limited to any specific or adapted meaning. The term may, without limitation, refer to at least the address in the memory of the hardware target at which the software coverage feedback is specifically stored. The specified address is therefore known. The specified address can be read out in a targeted manner, at least partially or else completely, by means of a debugger.

According to an example embodiment of the present invention, the method comprises the following steps, which can represent a first fuzzing iteration:
generating input data for the software program by means of a fuzzer;
transmitting the generated input data to the software program by means of the fuzzer;
monitoring at least one part of the specified address of the memory by means of a debugger while the software program at least partially processes the transmitted input data;
transmitting the change notification to the fuzzer when at least one change is detected in the monitored at least one part of the specified address of the memory.

In this way, the change notification can only be transferred if the software coverage has changed. This allows data transfer to be minimized.

The term “generating input data” as used herein is a broad term which should be given its ordinary and common meaning as understood by a person skilled in the art. The term is not limited to any specific or adapted meaning. The term can, without limitation, refer to the process of generating input data. The input data can be generated by means of the fuzzer. When generating the input data, the fuzzer can rely on a known input corpus with known input data, wherein the fuzzer generates new input data from the known input corpus. The fuzzer can take the change notification into account when generating input data, especially the further input data, so that the generated input data is generated depending on the change notification. For each fuzzer iteration, new input data can be generated which takes into account at least the most recently transmitted change notification.

The term “transmitting the generated input data” or code coverage as used herein is a broad term which should be given its ordinary and common meaning as understood by a person skilled in the art. The term is not limited to any specific or adapted meaning. The term can refer, without limitation, to the process of transferring the generated input data from the fuzzer to the software program. The transmitted input data can be processed by the software program. Typically, a host computer is provided on which the fuzzer is executed. The host computer may have an interface, in particular a physical interface. Furthermore, the hardware target may have an interface, in particular a physical interface. The input data can be transmitted via these interfaces.

The term “monitoring at least one part of the specified address of the memory” as used herein is a broad term which should be given its ordinary and common meaning as understood by a person skilled in the art. The term is not limited to any specific or adapted meaning. The term may refer, without limitation, to the process of continuously observing and controlling at least one part of the specified address of the memory. In particular, monitoring can be carried out in such a way that changes to the specified address of the memory can be detected.

The term “debugger” as used herein is a broad term which should be given its ordinary and common meaning as understood by a person skilled in the art. The term is not limited to any specific or adapted meaning. The term may refer, without limitation, to a device or software that can control the software program that is executed on the hardware target. The debugger can provide one or more functions to control the software program. The one or more functions may be or comprise reading at least one register and/or memory value of the memory of the hardware target, pausing, stopping and/or starting the execution of the software program, in particular such that the software program can be executed in individual steps.

In order to detect a change in the monitored at least one part of the specified address of the memory, change operations and write operations can be monitored, in particular exclusively. By means of the change operations and write operations, a change can be made to the content of the at least one address in the memory of the hardware target. This change can be detected when the software coverage changes.

According to an example embodiment of the present invention, to monitor the at least one part of the specified address of the memory by means of the debugger, one or more data breakpoints of the debugger can be set on the monitored at least one part of the specified address of the memory. A “data watchpoint” can be a function of the debugger that monitors access to the at least one part of the specified address of the memory. Typically, a memory size of at least one byte can be monitored by means of a data breakpoint. In order to monitor a data breakpoint by means of the debugger, the debugger may have an interface, in particular a physical interface, that couples to the memory of the hardware target. By means of the interface, the debugger can read the at least one part of the specified address of the memory.

A change in the specified address of the memory can be equated with a change in the software coverage. If the debugger detects a change in the specified address of the memory, the debugger can stop the execution of the software program.

The term “transmitting the change notification to the fuzzer” as used herein is a broad term that should be given its ordinary and common meaning as understood by a person skilled in the art. The term is not limited to any specific or adapted meaning. The term can refer, without limitation, to the process of transferring data to the fuzzer, wherein the change notification indicates to the fuzzer that the software coverage has changed. The change notification can only be transmitted to the fuzzer if a change has been detected at the specified address of the memory. The change notification can be transferred from the debugger to the fuzzer. As already explained, the host computer may have an interface, in particular a physical interface. Furthermore, the debugger may have an interface, in particular a physical interface. The change notification can be transmitted by means of these interfaces.

The one or more data breakpoints of the debugger may be set according to the fuzzing strategy of the fuzzer so that changes in the software coverage feedback relevant to the fuzzing strategy are detected.

The fuzzing strategy can in particular refer to the most complete possible development of the relevant block coverage. Preferably in this case, a specific data breakpoint of the one or more data breakpoints of the debugger may be set randomly. Alternatively or additionally, a specific data breakpoint of the one or more data breakpoints of the debugger may be set to a program section that has not yet been executed. Alternatively or additionally, at least one specific data breakpoint of the one or more data breakpoints of the debugger may be set such that a relevant program section is covered.

The fuzzing strategy may in particular refer to the most complete possible development of the relevant path coverage.

Preferably in this case, a specific data breakpoint of the one or more data breakpoints of the debugger can be set such that a plurality of sequentially adjacent program sections of the software program are captured by the specific data breakpoint. An assignment rule, wherein the assignment rule may preferably be a hash function, may be selected such that the plurality of sequentially adjacent program sections are stored on the memory of the hardware target such that they are placed on physically adjacent memory sections, which are preferably read out together from the specific data breakpoint. In this way, the number of required data breakpoints can be reduced.

According to an example embodiment of the present invention, to transmit the change notification to the fuzzer, the method may further comprise:
reading at least one part of the software coverage feedback by means of the debugger when changes are detected in the monitored at least one part of the specified address of the memory;
wherein the change notification is or comprises the part of the software coverage feedback read by the debugger.

According to an example embodiment of the present invention, the method may further comprise:
generating further input data for the software program by means of the fuzzer, taking into account the change notification transmitted to the fuzzer;
transmitting the generated further input data to the software program by means of the fuzzer;
further monitoring at least one part of the specified address of the memory by means of the debugger while the software program at least partially processes the transmitted further input data;
transmitting a further change notification to the fuzzer when at least one further change is detected in the monitored at least one part of the specified address of the memory.

These steps can represent a further fuzzing iteration. These steps can be repeated in one or more fuzzing iterations. These steps can be repeated until the fuzzing is aborted.

Before monitoring the one part of the specified address of the memory by means of the debugger, the method may comprise:
preparing the software coverage feedback at the specified address in the memory of the hardware target by at least one of the following method steps:
   transmitting one or more input values from a known input corpus to the software program by means of the fuzzer;
   writing a known software coverage feedback to the specified address of the memory, wherein the known software coverage feedback was preferably generated for a corresponding program version of the software program.

In a further aspect of the present invention, a system is disclosed, wherein the system comprises:
a host computer on which the fuzzer is executed;
a hardware debugger on which the debugger is executed;
a hardware target, wherein the hardware target preferably comprises or is a microcomputer,
wherein the system is configured to execute the computer-implemented method for obtaining a change notification from software coverage feedback during the fuzzing of a software program. For the disclosure relating to this aspect, any further aspect, embodiment and/or definition may be referenced or referred to.

In another aspect of the present invention, a computer program is disclosed which, when run on the system, executes the method for obtaining a change notification from software coverage feedback during the fuzzing of a software program. For the disclosure relating to this aspect, any further aspect, embodiment and/or definition may be referenced or referred to.

In a further aspect of the present invention, a computer-readable data carrier is disclosed on which a data structure is stored which, after being loaded into a working and/or main memory of the system, can execute the computer-implemented method for obtaining a change notification from software coverage feedback during the fuzzing of a software program.

The terms “computer-readable data carrier” and “computer-readable storage medium” as used herein may refer in particular to non-transitory data storage devices, such as a hardware data storage medium on which computer-executable instructions are stored. The computer-readable data carrier or the computer-readable storage medium can in particular be or comprise a storage medium such as a random access memory (RAM) and/or a read-only memory (ROM).

### BRIEF DESCRIPTION OF THE DRAWINGS

Further optional details and features of the present invention result from the following description of preferred exemplary embodiments shown schematically in the figures.

FIG. 1 is a schematic view illustrating a computer-implemented method for obtaining a change notification from software coverage feedback during the fuzzing of a software program according to an exemplary embodiment of the present invention.

FIG. 2 is a schematic view illustrating a system according to an exemplary embodiment of the present invention.

### DETAILED DESCRIPTION OF EXAMPLE EMBODIMENTS

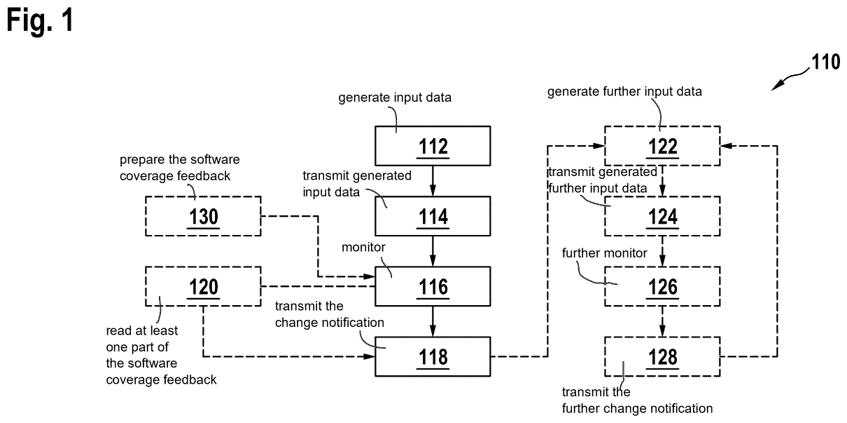

FIG. 1 illustrates an exemplary computer-implemented method for obtaining a change notification from software coverage feedback during the fuzzing of a software program 110. The method 110 is executed on a hardware target 138, wherein the software program is implemented with static source code instrumentation; wherein the software coverage feedback generated during execution of the software program is stored at a specified address in a memory of the hardware target 138. The method comprises the following steps:
generating input data 112 for the software program by means of a fuzzer;
transmitting the generated input data 114 to the software program by means of the fuzzer;
monitoring at least one part of the specified address of the memory 116 by means of a debugger while the software program at least partially processes the transmitted input data;
transmitting the change notification 118 to the fuzzer when at least one change is detected in the monitored at least one part of the specified address of the memory.

To transmit the change notification to the fuzzer, the method may further comprise:
reading at least one part of the software coverage feedback 120 by means of the debugger when changes are detected in the monitored at least one part of the specified address of the memory;
wherein the change notification is or comprises the part of the software coverage feedback read by the debugger.

The method can further comprise the following steps:
generating further input data 122 for the software program by means of the fuzzer, taking into account the change notification transmitted to the fuzzer;
transmitting the generated further input data 124 to the software program by means of the fuzzer;
further monitoring at least one part of the specified address of the memory 126 by means of the debugger while the software program at least partially processes the transmitted further input data;
transmitting a further change notification 128 to the fuzzer when at least one further change is detected in the monitored at least one part of the specified address of the memory.

To monitor at least one part of the specified address of the memory by means of the debugger, one or more data breakpoints of the debugger are set on the monitored at least one part of the specified address of the memory. The one or more data breakpoints of the debugger may be set according to the fuzzing strategy of the fuzzer so that changes in the software coverage feedback relevant to the fuzzing strategy are detected. A specific data breakpoint of the one or more data breakpoints of the debugger may be set such that a plurality of sequentially adjacent program sections of the software program are captured by the specific data breakpoint. An assignment rule, wherein the assignment rule is preferably a hash function, can be selected such that the plurality of sequentially adjacent program sections are stored on the memory of the hardware target 138 such that they are placed on physically adjacent memory sections.

To detect a change in the monitored at least one part of the specified address of the memory 116, 126, change operations and write operations can be monitored, in particular exclusively.

The software coverage feedback may be or comprise a bit-indexed coverage map.

Before monitoring the one part of the specified address of the memory 116 by means of the debugger, the method 110 may comprise:
preparing the software coverage feedback 130 at the specified address in the memory of the hardware target by at least one of the following method steps:
   transmitting one or more input values from a known input corpus to the software program by means of the fuzzer;
   writing a known software coverage feedback to the specified address of the memory, wherein the known software coverage feedback was preferably generated for a corresponding program version of the software program.

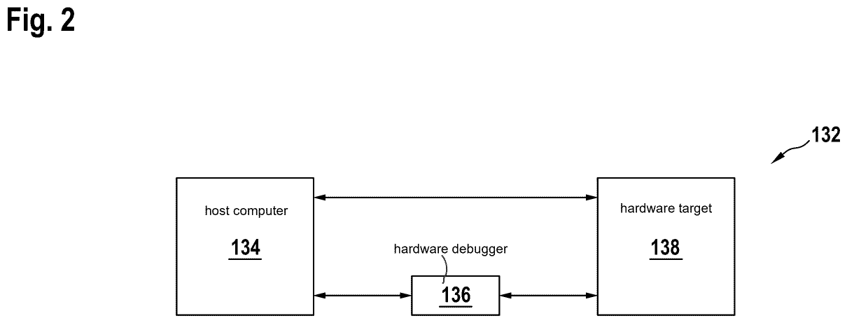

FIG. 2 shows an exemplary system 132, wherein the system comprises:
a host computer 134 on which the fuzzer is executed;
a hardware debugger 136 on which the debugger is executed;
a hardware target 138, wherein the hardware target preferably comprises or is a microcomputer,
wherein the system is configured to execute the computer-implemented method for obtaining a change notification from software coverage feedback during the fuzzing of a software program. The system can be a hardware in the loop (HiL) system.

The data flow between the individual hardware components 134, 136, 138 can occur as shown by the arrows. The data flow can occur via appropriately configured physical interfaces.

1-13. (canceled)

14. A computer-implemented method for obtaining a change notification from software coverage feedback during the fuzzing of a software program that is executed on a hardware target, wherein the software program is implemented with static source code instrumentation, wherein the software coverage feedback generated during execution of the software program is stored at a specified address in a memory of the hardware target, the method comprising the following steps:
generating input data for the software program by means of a fuzzer;
transmitting the generated input data to the software program using the fuzzer;
monitoring at least one part of the specified address of the memory using a debugger while the software program at least partially processes the transmitted input data; and
transmitting the change notification to the fuzzer when at least one change is detected in the monitored at least one part of the specified address of the memory.

15. The method according to the claim 14, wherein, for transmitting the change notification to the fuzzer, the method further comprises the following steps:
reading at least one part of the software coverage feedback using the debugger when changes are detected in the monitored at least one part of the specified address of the memory;
wherein the change notification includes the at least one part of the software coverage feedback read by the debugger.

16. The method according to claim 14, wherein the method further comprises:
generating further input data for the software program using the fuzzer, taking into account the change notification transmitted to the fuzzer;
transmitting the generated further input data to the software program using the fuzzer;
further monitoring at least one part of the specified address of the memory using the debugger while the software program at least partially processes the transmitted further input data;
transmitting a further change notification to the fuzzer when at least one further change is detected in the monitored at least one part of the specified address of the memory.

17. The method according to claim 14, wherein, to monitor at least one part of the specified address of the memory using the debugger, one or more data breakpoints of the debugger are set on the monitored at least one part of the specified address of the memory.

18. The method according to claim 17, wherein the one or more data breakpoints of the debugger are set according to a fuzzing strategy of the fuzzer, so that changes in the software coverage feedback relevant to the fuzzing strategy are detected.

19. The method according to claim 17, wherein a specific data breakpoint of the one or more data breakpoints of the debugger is set such that a plurality of sequentially adjacent program sections of the software program are captured by the specific data breakpoint.

20. The method according to the claim 14, wherein an assignment rule is selected such that the plurality of sequentially adjacent program sections are stored on the memory of the hardware target such that the plurality of sequentially adjacent program sections are placed on physically adjacent memory sections.

21. The method according to claim 20, wherein the assignment rule includes a hash function.

22. The method according to claim 14, wherein, wherein to detect a change in the monitored at least one part of the specified address of the memory, change operations and write operations are monitored.

23. The method according to claim 22, wherein the change operations and the write operations are monitored exclusively.

24. The method according to claim 14, wherein the software coverage feedback includes a bit-indexed coverage map.

25. The method according to claim 14, wherein, prior to monitoring the one at least one part of the specified address of said memory using the debugger, the method comprises:
preparing the software coverage feedback at the specified address in the memory of the hardware target by at least one of the following method steps:
transmitting one or more input values from a known input corpus to the software program using the fuzzer;
writing a known software coverage feedback to the specified address of the memory, wherein the known software coverage feedback was generated for a corresponding program version of the software program.

26. A system, comprising:
a host computer on which a fuzzer is executed;
a hardware debugger on which a debugger is executed;
a hardware target including a microcomputer;
wherein the system is configured to execute a computer-implemented method for obtaining a change notification from software coverage feedback during a fuzzing of a software program that is executed on the hardware target, wherein the software program is implemented with static source code instrumentation, wherein the software coverage feedback generated during execution of the software program is stored at a specified address in a memory of the hardware target, the method comprising the following steps:
generating input data for the software program by means of the fuzzer,
transmitting the generated input data to the software program using the fuzzer,
monitoring at least one part of the specified address of the memory using the debugger while the software program at least partially processes the transmitted input data, and
transmitting the change notification to the fuzzer when at least one change is detected in the monitored at least one part of the specified address of the memory.

27. A non-transitory computer-readable data carrier on which is stored a data structure is stored which, after being loaded into a working and/or main memory of a system including a host computer on which a fuzzer is executed, a hardware debugger on which a debugger is executed, and a hardware target including a microcomputer, executes a method for obtaining a change notification from software coverage feedback during a fuzzing of a software program that is executed on the hardware target, wherein the software program is implemented with static source code instrumentation, wherein the software coverage feedback generated during execution of the software program is stored at a specified address in a memory of the hardware target, the method comprising the following steps:
generating input data for the software program by means of the fuzzer;
transmitting the generated input data to the software program using the fuzzer;
monitoring at least one part of the specified address of the memory using the debugger while the software program at least partially processes the transmitted input data; and
transmitting the change notification to the fuzzer when at least one change is detected in the monitored at least one part of the specified address of the memory.
